(19) United States
(12) Patent Application Publication
(10) Pub. No.: US 2026/0213972 A1
(43) Pub. Date: Jul. 23, 2026

(54) METHODS AND SYSTEMS FOR APPLIANCE LOG DATA INVESTIGATION

(71) Applicant: ELECTROLUX APPLIANCES AKTIEBOLAG, Stockholm (SE)

(72) Inventor: Charles Jameson, Stockholm (SE)

(73) Assignee: ELECTROLUX APPLIANCES AKTIEBOLAG, Stockholm (SE)

(21) Appl. No.: 19/140,807

(22) PCT Filed: Dec. 8, 2023
(86) PCT No.: PCT/EP2023/084881

§ 371 Date: Jun. 18, 2025

(30) Foreign Application Priority Data
Dec. 19, 2022 (GB) 2219199.3

(51) Int. Cl. H04L 12/28; G06Q 10/20; H04L 67/125

(52) U.S. Cl. CPC H04L 12/2825; G06Q 10/20; H04L 67/125; H04L 2012/285

(57) ABSTRACT

A method carried out by an appliance management system comprising one or more servers is disclosed. The method comprises processing an instruction to carry out a log data investigation for a remote electric appliance, the electric appliance locally storing appliance log data regarding the operation of the electric appliance. The method further comprises, based on said processing, carrying out: transmitting, over a communication network, a request for appliance log data to the electric appliance; receiving, over the communication network, from the electric appliance an appliance data packet comprising at least a portion of recent appliance log data among the appliance log data locally stored at the electric appliance.

### BACKGROUND OF THE PRESENT INVENTION

### Field of the Present Invention

The present invention generally relates to methods and systems for managing electric appliances. Particularly, the present invention relates to methods and systems for carrying out log data investigations for electric appliances.

### OVERVIEW OF THE RELATED ART

In recent years, there has been rapid advancement in connected or smart environments. A typical connected or smart environment is implemented by a wireless communication network (e.g., a Wi-Fi™ communication network) and allows client devices connected to (or accessing) the wireless communication network to connect to each other and/or to other (external) communication network (such as the Internet network).

An increasing number of electric appliances (both household appliances for domestic use and professional appliances for professional use) now offer networking capability supporting connectivity to a Wi-Fi network (for example by directly establishing connection with a Wi-Fi router or by exploiting other communication devices, such as smartphones, tablets, laptops), and therefore to external communication networks like the Internet.

For this reason, method and systems have been developed in recent times that exploit the networking capability of electric appliances for the transmission of appliance specific data-pertaining to the operation of the electric appliance—to remote entities for maintenance purposes, such as for example for the transmission of the appliance log data to a remote maintenance center. Following a typical operation of a household appliance, a connected appliance may automatically send a relatively small amount of data to a maintenance and/or control center. However, some appliances would typically have generated a larger amount of data, most of which is not transmitted due to technical and cost restraints. As a specific, purely illustrative, example, a typical operation may generate at least a few megabytes of data but the appliance may only send a fraction of that data, for example around 10% or 100 to 200 kilobytes, to a maintenance and/or control center. The transmitted data may not be sufficiently detailed for a maintenance center to trouble-shoot successfully if there is a fault in the machine or for R&D purposes for determining complex underlying root causes. A diagnostic cycle of the machine, initiated for example by the user upon identification of a fault, may generate of the order of a few megabytes of data.

EP1095440 discloses a system for the monitoring and/or the remote technical service, prior to a local maintenance operation, of a plurality of electric users, in particular household appliances, belonging to a same household environment, comprising a specific monitoring device capable of collecting through a local network connected with the users (in particular the same power supply network), and storing in a suitable nonvolatile but updatable electronic memory (such as FLASH or EEPROM memory), functional, diagnostic and statistical information generated and made available on said local network by said household users. The monitoring device comprises proper means to receive, manage and make explicit said information received from said household users, where said information may be made explicit at a local level, directly to the utilizer, and/or at a remote level within the household environment (such as for instance to a personal computer eventually available in such an environment and properly interfaced with said local network) and/or finally at a remote level, i.e. outside the household environment, to a specific center for the technical service and/or preventive maintenance prior to a local operation for said plurality of household users.

U.S. Pat. No. 7,295,099 discloses a home appliance network system and a method for operating the same. The home appliance network system comprises a plurality of home appliances connected to a network constructed in a home for transmitting and receiving data over the network, and a home server including a device monitoring module for independently storing and updating state information or product information of a specific one of the home appliances based on an input control command. When a user monitors product information of the home appliances to control the home appliances, the home server more rapidly displays the product information, resulting in an improvement in control speed. Further, the home server uses a smaller amount of network system resources, thereby enabling efficient networking to be made.

EP 3170134 discloses a home appliance and a control method for the same. The home appliance includes an operation unit that receives a control command, a sensor unit that detects a status of the home appliance, a control unit that outputs a control signal so that the home appliance is operated according to the control command, and a driving unit that is operated according to the control signal. Here, the control unit manages a usage log by accumulating and recording at least one of information of an input of the control command and information of the status of the home appliance.

### SUMMARY OF THE PRESENT INVENTION

The Applicant has realized that the abovementioned solutions known in the art are affected by drawbacks.

The solution disclosed in EP1095440 requires to periodically send functional, diagnostic and statistical information data about the operation of household appliances. Periodically sending a large amount of data is disadvantageous in terms of storage/transmission cost, and may potentially introduce delays in the correct operations of the household appliances. Moreover, the solution disclosed in EP1095440 requires the use of a specific and dedicated monitoring device configured for collecting the data from the household appliances.

The solution disclosed in U.S. Pat. No. 7,295,099 requires the installation of a home server including a device monitoring module for storing and updating state information of the home appliances. Furthermore, in U.S. Pat. No. 7,295,099, no remote transmission of the state information is made toward remote entities.

In the solution disclosed in EP 3170134, the transmission of a usage log (comprising information regarding the operation of the appliance) from the appliance to a remote failure management device is triggered by the appliance itself.

In view of the above, the Applicant has devised a solution that is not affected by at least one or more of the drawbacks affecting the known solutions. Particularly, the Applicant has devised an efficient solution for the transmission of appliance log data from an electric appliance to one or more remote entities that does not require the sending of large amount of data, that does not require the use and/or installation of dedicated additional devices, and that does not require heavy processing computation from the electric appliance side.

One or more aspects of the present invention are set out in the independent claims, with advantageous features of the same invention indicated in the dependent claims, whose wording is enclosed herein verbatim by reference (with any advantageous feature being provided with reference to a specific aspect of the present invention that applies mutatis mutandis to any other aspect thereof).

An aspect of the present invention relates to a method carried out by an appliance management system comprising one or more servers.

The method comprises processing an instruction to carry out a log data investigation for a remote electric appliance.

The electric appliance locally stores appliance log data regarding the operation of the electric appliance.

The method comprises, based on said processing, carrying out:
transmitting, over a communication network, a request for appliance log data to the electric appliance;
receiving, over the communication network, from the electric appliance an appliance data packet comprising at least a portion of recent appliance log data among the appliance log data locally stored at the electric appliance.

Since the electric appliance is configured to transmit the appliance data packet in response to the reception of the request for appliance log data from a server, the electric appliance is advantageously freed from the burden of deciding if (and when) actually carrying out the transmission of appliance log data to the appliance management system, reducing the complexity of the operations to be carried out by the electric appliance.

According to an embodiment of the present invention, said appliance log data comprise at least one among:
appliance usage data indicative of interactions between a user and the electric appliance during the operation of the electric appliance;
telemetric data collected by sensors onboard the electric appliance during the operation of the electric appliance.

In this way, the appliance management system may collect detailed information about the electric appliance and its operation, from which it is possible to obtain a through and complete picture of the state of the electric appliance.

According to an embodiment of the present invention, said at least a portion of recent appliance log data may comprise at least a most recent portion.

According to an embodiment of the present invention, said appliance data packet comprises at least one among:
appliance log data regarding an operation of the electric appliance during a time period comprising the last, most recent, operation of the electric appliance;
appliance log data regarding one or more recent operation cycles carried out by the electric appliance. The one or more recent operation cycles could include the most recent operation cycle. The one or more recent operation cycles could be a single operation cycle, for example the most recent operation cycle.

In this way, the amount of data contained in the appliance data packet, and therefore the amount of data to be transmitted from the electric appliance to the appliance management system, can be kept low, reducing the time and/or bandwidth required for the transmissions and the computational costs thereof, increasing at the same time the efficiency of the appliance management system. It also reduces the amount of storage space needed for appliance log data in the appliance management system.

According to an embodiment oof the present invention, said instruction to carry out a log data investigation is triggered by an assessment of the malfunctioning of the electric appliance.

In this way, the transmission of the appliance log data is advantageously carried out only when the data is needed by the appliance management system, reducing the bandwidth required for transmissions and the storage space needed in the appliance management system.

According to an embodiment of the present invention, the method further comprises receiving from the electric appliance or a user communication device associated with the electric appliance an appliance malfunctioning message indicative of a malfunctioning of the electric appliance.

According to an embodiment of the present invention, the method further comprises carrying out said assessment of the malfunctioning of the electric appliance based on said appliance malfunctioning message.

According to an embodiment of the present invention, when the transmission of the request is carried out upon the assessment of a malfunctioning of the electric appliance, the method further comprising:
analyzing the received appliance data packet;
identifying a cause of said malfunctioning based on the analyzed appliance data packet.

According to an embodiment of the present invention, the method further comprises transmitting a message to a user communication device associated with the electric appliance to notify a user of the electric appliance about the identified cause and/or a repair solution.

According to an embodiment of the present invention, the method further comprises transmitting a message to a maintenance service entity to inform the maintenance service entity about the identified cause and to automatically schedule an intervention by a maintenance person directed to fix the electric appliance malfunctioning.

According to an embodiment of the present invention, said instruction to carry out a log data investigation is triggered via a customer service interface device associated with the one or more servers by a user input.

According to an embodiment of the present invention, the method further comprises providing the at least a portion of recent appliance log data to the customer service interface device for display to a customer service operator.

According to an embodiment of the present invention, said communication network comprises a mobile telecommunication network and/or the Internet.

Another aspect of the present invention relates to a method carried out by an electric appliance. The method comprises locally storing appliance log data regarding the operation of the electric appliance.

The method comprises receiving a request of appliance log data from a remote server.

The method comprises, in response to the received request, sending to the remote server an appliance data packet comprising at least a portion of most recent appliance log data among the locally stored appliance log data.

According to an embodiment of the present invention, the method further comprises overwriting previously stored appliance log data regarding a past operation of the electric appliance with new appliance log data regarding a new operation of the electric appliance.

In this way, the amount of memory space occupied by the log stored in the storage unit of the electric appliance is advantageously kept within a predetermined limit.

According to an embodiment of the present invention, the method further comprises controlling sensors onboard the electric appliance to record telemetric data during operation of the electric appliance.

According to an embodiment of the present invention, said appliance log data comprise at least a portion of the recorded telemetric data.

According to an embodiment of the present invention, the method further comprises detecting user inputs at a user interface of the electric appliance.

According to an embodiment of the present invention, said appliance log data comprises user input data indicative of at least some of said detected user inputs.

According to an embodiment of the present invention, said appliance data packet comprises at least one among:
appliance log data regarding an operation of the electric appliance during a time period comprising the last, most recent, operation of the electric appliance;
appliance log data regarding one or more recent operation cycles carried out by the electric appliance. The one or more recent operation cycles could include the most recent operation cycle. The one or more recent operation cycles could be a single operation cycle, for example the most recent operation cycle.

According to an embodiment of the present invention, the method further comprises, prior to receiving the request for appliance log data, transmitting an appliance malfunctioning message indicative of a malfunctioning of the electric appliance.

According to an embodiment of the present invention, the method further comprises receiving a follow-up request for additional appliance log data from the remote server and in response to the follow-up request, sending to the remote server another appliance data packet comprising an additional portion of recent appliance log data, said at least a portion being more recent log data than said additional portion.

Another aspect of the present invention relates to an electric appliance.

The electric appliance comprises a storage unit configured to store appliance log data regarding the operation of the electric appliance.

The electric appliance comprises a communication unit configured to exchange data and messages with a remote server over a communication network.

The electric appliance comprises a control unit configured to control the communication unit to send appliance log data to the remote server in response to the reception of a request of appliance log data from the remote server.

The appliance log data sent in response to the request comprises at least a portion of most recent appliance log data among the appliance data stored in the storage unit.

Another aspect of the present invention relates to an appliance management system comprising one or more servers.

Said one or more servers comprise a processing unit configured to process an instruction to carry out a log data investigation for a remote electric appliance.

Said one or more servers comprise a communication unit configured to:
based on said instruction processed by the processing unit, transmit, over a communication network, to said electric appliance a request of appliance log data, said appliance log data being data regarding the operation of the electric appliance that are locally stored at the electric appliance;
receive, over the communication network, from the electric appliance at least a portion of most recent appliance log data among the appliance log data locally stored at the electric appliance.

According to an embodiment of the present invention, said processing unit is further configured to analyze the received appliance log data and identify a cause of a malfunctioning of the electric appliance based on the analyzed appliance log data.

Another aspect of the present invention relates to a computer program configured to be executed on said one or more servers.

Another aspect of the present invention relates to a computer program configured to be executed on said electric appliance.

### BRIEF DESCRIPTION OF THE DRAWINGS

FIG. 1 depicts an electric appliance and an appliance management system according to an embodiment of the present invention;

FIG. 2 is an activity diagram of a method implementing a remote log data investigation for the electric appliance by the appliance management system of FIG. 1, according to an embodiment of the present invention.

### DETAILED DESCRIPTION OF EXEMPLARY AND NON-LIMITATIVE EMBODIMENTS OF THE PRESENT INVENTION

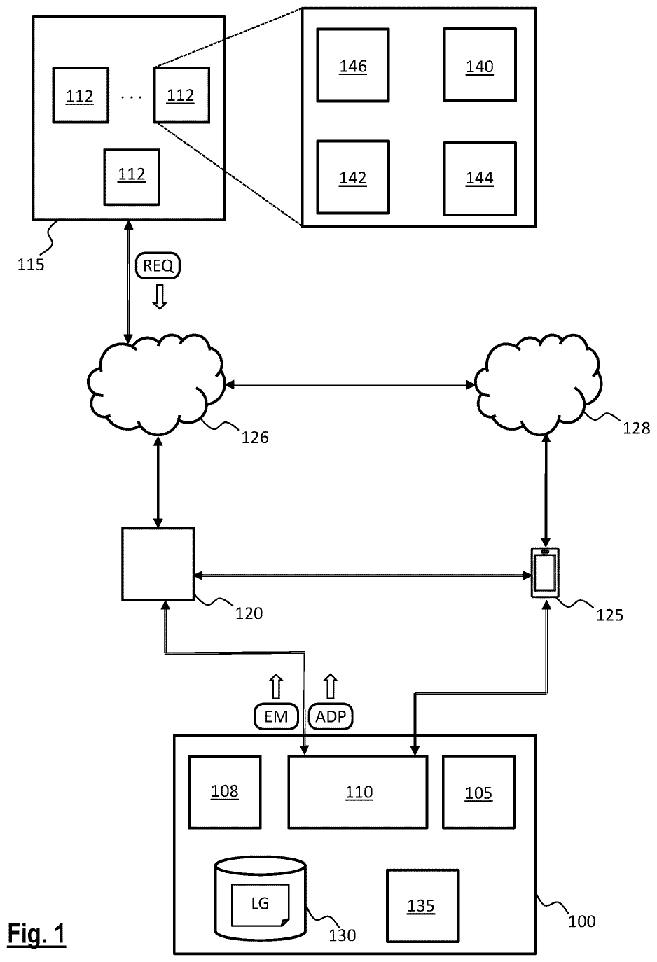

With reference to the drawings, FIG. 1 schematically depicts an electric appliance, identified with reference 100.

Without losing generality, the electric appliance 100 may comprise any household appliance for domestic use or professional appliance for professional use. Examples of electric appliances include, but are not limited to, small electric appliances (such as microwave ovens, toasters, humidifiers, food processors and coffeemakers) and large electric appliances (such as freezers, refrigerators, water coolers, ice makers, kitchen stoves, cooking hobs, ovens, washing machines, drying machines, combined washing/drying machines, dishwashers, and air conditioners).

In the following, only components of the electric appliance 100 deemed relevant for the understanding of the present disclosure will be discussed for the sake of conciseness.

It should be noted that the terms ‘unit’, “system’, ‘module’ are herein intended to comprise, but not limited to, hardware, firmware, a combination of hardware and software, or software.

According to an embodiment of the invention, the electric appliance 100 comprises a control unit 105 configured to control an operation of the electric appliance 100. According to an embodiment, the control unit 105 is configured to control the operation of the electric appliance 100 by driving corresponding (not illustrated) electric, electronic, electromechanical, electromagnetic and/or hydraulic apparatuses/systems/modules/units of the electric appliance 100 based on one or more functionalities (e.g., selected operation programs) of the electric appliance 100.

According to an embodiment, the control unit 105 is configured to control the operation of the electric appliance 100 according to commands submitted by a user of the electric appliance 100 through a user interface 108 of the electric appliance 100. The submitted commands may specify the selection of a functionality (program) of the electric appliance 100 and/or operational parameters influencing the selected functionality (program). Without losing generality, the user interface 108 may for example be provided on the electric appliance 100, and comprise for example one or more among buttons, knobs, levers, keys, touchscreens, displays. A virtualized version of the user interface 108 may be also provided, allowing to submit commands by a software application running (or designed to run) on a user device (such as a mobile application designed to run on a mobile device such as a smartphone, a tablet, or a smartwatch or a desktop application running (or designed to run) on desktop and laptop computers).

According to an embodiment of the present invention, the electric appliance 100 further comprises a communication unit 110 configured to allow data communication between the electric appliance 100 and remote apparatuses over a communication network. According to an embodiment of the present invention, said remote apparatuses comprises one or more servers 112 of an appliance management system 115 implementing a (remote) management (e.g., customer support, maintenance, repair) service for the electric appliance 100. The servers may form part of a data storage and processing cloud providing remote data storage and processing services via a communication network.

According to an embodiment of the present invention, the communication unit 110 comprises a Wi-Fi communication module for allowing wireless connection of the household appliance 100 to a Wi-Fi router 120, for example via a home Wi-Fi network. The Wi-Fi router 120 is configured to set-up an access point for allowing communication with an external communication network 126, such as the internet, through which the electric appliance 100 and the one or more servers 112 of the appliance management system 115 may exchange (transmit/receive) data.

According to another embodiment of the present invention, the communication unit 110 further comprises a short-range radio signal module for allowing direct wireless connection of the electric appliance 100 to a user communication device 125 (e.g., a smartphone, a tablet, a laptop) over a short-range radio communication channel, exploiting one or more among the Bluetooth™, ultra-wideband (UWB), NFC, RFID, and ZigBee™ technologies.

Yet further, in some of the described or other embodiments, the appliance may be configured to directly communicate with the user communication device 125 using a/the Wi-Fi communication module.

The user communication device 125 may further be configured to exchange data with the appliance management system to control and/or monitor the electric appliance. The user communication device 125 may be configured to allow communication with a mobile telecommunication network 128 which is in turn in communication with the external communication network 126, so that the user communication device 125 and the one or more servers 112 of the appliance management system 115 may exchange (transmit/receive) data over the networks 126, 128. The user communication device 125 may be also, or alternatively, configured to access the external communication network 126 through the Wi-Fi router 120, to allow data communication between the user communication device 125 and the one or more servers 112 of the appliance management system 115 without involving the mobile telecommunication network 128.

Although specific types of communication networks have been described herein it will be appreciated that any type of suitable communication networks, and corresponding communication modules, may be used to allow communication between the appliance, the appliance management system and the user communication device.

According to an embodiment of the present invention, the electric appliance 100 comprises a memory unit 130 including one or more memory devices for locally storing programs and data used by the control unit 105 for controlling the operation of the electric appliance 100.

According to an embodiment of the present invention, the memory unit 130 comprises one or more memory devices (the same ones or different from the ones storing the abovementioned programs and data) for locally storing appliance log data ALD regarding the operation of the electric appliance 100. The memory 130 for storing the appliance log data ALD may comprise rewritable memory to allow old appliance log data ALD to be overwritten with new appliance log data ALD.

For example, the storage unit 130 may comprise one or more non-volatile memory devices and/or mass-memory devices.

According to an embodiment of the present invention, the appliance log data ALD comprise appliance usage data indicative of interactions between a user and the electric appliance 100 during the operation of the electric appliance 100 itself. For example, the appliance usage data AUD may comprise one or more among:
data regarding commands submitted by a user through the user interface 108, such as for example the activation/deactivation of the electric appliance 100, the selection of a functionality (program) of the electric appliance 100, the setting of operational parameters influencing the selected functionality (program);
data regarding direct interactions between the user and the electric appliance 100, such as for example the opening/closing of a door/drawer/compartment of the electric appliance 100, the application/removal/substitution of an accessory to/from/of the electric appliance 100.

According to an embodiment of the present invention—in addition to or in the place of the appliance usage data AUD—the appliance log data ALD comprise telemetric data TD collected by one or more sensors (only one illustrated in FIG. 1, and identified with reference 135) onboard the electric appliance 100 during the operation of the electric appliance 100. For example, the telemetric data TD may comprise one or more among data regarding electric parameters (current, voltage, power consumption, . . . ), mechanical parameters (torque, speed, mass, . . . ), hydraulic parameters (mass/volumetric flow rate, . . . ), thermodynamic parameters (pressure, temperature) of (or associated with, or pertaining to) apparatuses/systems/modules/units of the electric appliance 100.

According to an embodiment of the present invention, the appliance log data ALD are stored in the form of an ordered log LG comprising a sequence of entries L (i) (i=1, 2, 3, . . . ) each one comprising appliance log data ALD corresponding to an electric appliance event E(i) occurred at a corresponding time t (i) of the operation of the electric appliance 100 during which corresponding actions/measurements are performed. The generic event E(i) occurs at a time t (i) following the time t (i-1) of occurrence of the previous event E(i-1) in the sequence of entries L (i).

By making reference to an exemplary and non-limitative case in which the electric appliance 100 is a washing machine configured to treat (wash) laundry, a (simplified) example of (a portion of) an exemplary log LG stored in the storage unit 130 corresponding to an operation cycle of the washing machine for carrying out a washing program WP comprising a sequence of three phases, and namely a wash phase C1, a rinse phase C2 and a spin phase C3, is reported hereinbelow.

| Entry | Event | Time | Actions/Measurements |
|---|---|---|---|
| L(1) | E(1) = activation of | t(1) = hh:mm:ss | Power on button pressed |
| | appliance | | Activation procedure initiated |
| L(2) | E(2) = door opening | t(2) = hh:mm:ss | Door opened |
| | | | Laundry load procedure initiated |
| L(3) | E(3) = door closing | t(3) = hh:mm:ss | Door closed |
| | | | Laundry load procedure ended |
| L(4) | E(4) = selection of operation | t(4) = hh:mm:ss | Interaction with selection knob |
| | cycle (washing program) to | | Selection of washing program WP |
| | be performed, comprising | | providing for an operation cycle |
| | phases C1, C2, C3 | | comprising phases C1, C2, C3 |
| L(5) | E(5) = subphase pc1 of phase | t(5) = hh:mm:ss | Phase C1 start |
| | C1 of the operation cycle | | Washing fluid diverter on position xxx |
| | | | Inlet vale activated |
| | | | Washing fluid level: xxx |
| | | | Washing fluid Flow rate: xxx |
| L(6) | E(6) = subphase pc2 of phase | t(6) = hh:mm:ss | Washing fluid level: xxx |
| | C1 of the operation cycle | | Rotation of drum |
| | | | Drum motor current: xxx |
| | | | Drum rotation speed: xxx |
| | | | Activation of heating resistor |
| | | | Heating resistor current: xxx |
| | | | Washing fluid Flow rate: xxx |
| L(7) | E(7) = subphase pc3 of phase | t(7) = hh:mm:ss | Washing fluid level: xxx |
| | C1 of the operation cycle | | Rotation of drum |
| | | | Drum motor current: xxx |
| | | | Drum rotation speed: xxx |
| | | | Deactivation of heating resistor |
| | | | Inlet vale deactivated |
| L(8) | E(8) = subphase pc4 of phase | t(8) = hh:mm:ss | Rotation of drum |
| | C1 of the operation cycle | | Drum motor current: xxx |
| | | | Drum rotation speed: xxx |
| L(9) | E(9) = subphase pc5 of phase | t(9) = hh:mm:ss | Rotation of drum |
| | C1 of the operation cycle | | Drum motor current: xxx |
| | | | Drum rotation speed: xxx |
| L(10) | E(10) = subphase pc5 of | t(10) = hh:mm:ss | Interruption of drum rotation |
| | phase C1 of the operation | | |
| | cycle | | |
| L(11) | E(11) = subphase pc6 of | t(11) = hh:mm:ss | Washing fluid level: xxx |
| | phase C1 of the operation | | Activation of drain pump |
| | cycle | | Drain pump current: xxx |
| L(12) | E(12) = subphase pc7 of | t(12) = hh:mm:ss | Washing fluid level: xxx |
| | phase C1 of the operation | | Deactivation of drain pump |
| | cycle | | Phase C1 end |
| L(13) | E(13) = subphase pc1 of | t(13) = hh:mm:ss | Phase C2 start |
| | phase C2 of the operation | | Washing fluid diverter on position xxx |
| | cycle | | Inlet vale activated |
| | | | Water level: xxx |
| | | | Water Flow rate: xxx |
| L(14) | E(14) = subphase pc2 of | t(14) = hh:mm:ss | Water level: xxx |
| | phase C2 of the operation | | Inlet vale deactivated |
| | cycle | | Rotation of drum |
| | | | Drum motor current: xxx |
| | | | Drum rotation speed: xxx |
| L(15) | E(15) = subphase pc3 of | t(15) = hh:mm:ss | Water level: xxx |
| | phase C2 of the operation | | Rotation of drum |
| | cycle | | Drum motor current: xxx |
| | | | Drum rotation speed: xxx |
| L(16) | E(16) = subphase pc4 of | t(16) = hh:mm:ss | Interruption of drum rotation |
| | phase C2 of the operation | | |
| | cycle | | |
| L(17) | E(17) = subphase pc5 of | t(17) = hh:mm:ss | Activation of drain pump |
| | phase C2 of the operation | | Drain pump current: xxx |
| | cycle | | Water level: xxx |
| L(18) | E(18) = subphase pc6 of | t(18) = hh:mm:ss | Water level: xxx |
| | phase C2 of the operation | | Deactivation of drain pump |
| | cycle | | Phase C2 end |
| L(19) | E(19) = subphase pc1 of | t(19) = hh:mm:ss | Phase C3 start |
| | phase C3 of the operation | | Rotation of drum |
| | cycle | | Drum motor current: xxx |
| | | | Drum rotation speed: xxx |
| L(20) | E(20) = subphase pc2 of | t(20) = hh:mm:ss | Interruption of drum rotation |
| | phase C3 of the operation | | Phase C3 end |
| | cycle | | |

According to an embodiment of the present invention, the entries L (i) of the log LG are stored in the storage unit 130 in an incremental way, such as for example each entry L (i) is stored in the storage unit 130 once the corresponding event E(i) is carried out. Similar considerations apply in case the entries L (i) are not immediately stored in the storage unit 130 (for example, a batch of a plurality of entries L (i) may be, e.g., periodically, stored in the storage unit 130), provided that the corresponding times t (i) correctly specify the time during which the corresponding actions/measurements have been carried out. As an example, all the entries in the log LG for a single typical washing machine cycle may take up approximately 2 MB of memory. When the storage unit comprises rewritable memory, existing entries of the LG, corresponding to a past operation cycle of the appliance, in the storage unit may be overwritten with new entries from a current operation cycle.

Although an exemplary log has been described with respect to an operation cycle of a washing machine, corresponding logs can be created for other types of appliances. Any reference to operation cycle herein shall be understood to include reference to any operation or operation session of an appliance if appropriate from the context.

According to an embodiment of the present invention, the generic server 112 of the appliance management system 115 comprises a server processing unit 140, such as comprising one or more CPUs, configured to carry out computing tasks by running program instructions loaded in a main server memory 142, such as comprising one or more RAM memory banks, a server storage memory unit 144, such as comprising one or more non-volatile memory devices and/or mass-memory devices, for locally storing programs to be loaded in the main server memory 142 and generic data, and a server communication unit 146 configured to allow data communication between the server 112 and remote apparatuses, such as the electric appliance 110 over a communication network, such as the external communication network 126. The server communication unit 146 may also be arranged to allow for internal communication between the servers. In some implementation, one or more servers 112 may be arranged to handle all communication with the external communication network 126 and may route received data to one or more other servers 112 for processing or forward data from the one or more servers. Herein, when is it is described that a server communication unit 146 receives appliance log data ALD this also includes receiving appliance log data forwarded from another server 112. Moreover, when “a” or “the” server is referred to herein, it should be understood to include “one or more” or “the one or more” servers as appropriate.

According to an embodiment of the present invention, the appliance management system 115 is configured to carry out a remote log data investigation on appliance log data ALD of the log LG by exploiting the data communication that can be established between the electric appliance 100 and the server(s) 112 of the appliance management system 115 over the external communication network 126. Thus, by having access to the appliance log data ALD, the appliance management system 115 may collect detailed information about the electric appliance 100 and its operation, from which it is possible to obtain a thorough and complete picture of the state of the electric appliance 100. In this way, the appliance management system 115 may implement an efficient remote management service for the electric appliance 100.

For example, if the electric appliance 100 has malfunctioned, appliance log data ALD from its stored log LG may be processed by (the server processing unit 140 of) one or more of the servers 112 of the appliance management system 115 and analyzed to identify a cause of the malfunctioning. For example, the appliance log data ALD may be forwarded to an analytics engine forming part of, or external to, the appliance management system 115. The higher the detail of the appliance log data ALD of the log LG, the better the identification of the cause of malfunctioning. Indeed, from the inspection of a log LG comprising a large number of details, it is possible to precisely assess several important information useful for the identification of the cause of a malfunctioning, such as for example:
anomalous value(s) observed from collected measurements;
the apparatuses/systems/modules/units of the electric appliance 100 involved in said observed anomalous value(s);
the time(s) t (i) of occurrences of these anomalous values;
the event(s) E(i) of the electric appliance 100 involved in the malfunctioning;
the configuration of the electric appliance 100;
the interactions between the user and the electric appliances 100 during the operation of the latter; and/or
an history of the operation of the electric appliance 100 before the malfunctioning.

By making reference to the exemplary log LG listed above, a malfunctioning caused by a broken drain pump may be for example assessed by identifying an anomalous value in the current of the drain pump during the activation of the drain pump at event E(11) (entry L (11) of the log LG) and/or by identifying an anomalous value of the washing fluid level in the tub carried out at event E(12) (entry L (12) of the log LG).

According to an embodiment of the present invention, a server 112 of the appliance management system 115 is configured in such a way as to notify a user of the electric appliance 100 about the cause of malfunctioning of the electric appliance 100 that has been identified through the inspection of the appliance log data ALD. For example, a notification message may be sent to a user communication device associated with the electric appliance 100, such as the user communication device 125, comprising the details of the cause of the malfunctioning. By making reference to the example at issue, the notification message may comprise the message “drain pump malfunctioning”. According to an embodiment of the present invention, a repair solution message may be also sent together with the notification message, providing an indication for repairing the malfunctioning. By making reference to the example at issue, the notification message may comprise the message “substitute drain pump”.

According to an embodiment of the present invention, a server 112 of the appliance management system 115 is configured in such a way as to notify a maintenance service entity about the cause of malfunctioning of the electric appliance 100 that has been identified through the inspection of the appliance log data ALD in order to schedule an intervention by a maintenance person directed to fix the malfunctioning of the electric appliance 100. For example, a notification message may be sent to the maintenance service entity comprising the details of the cause of the malfunctioning (e.g., “drain pump malfunctioning”), and/or details obtained from the appliance log data ALD of the log LG-such as for example a portion of the log LG (e.g., comprising data about the evolution in time of the current drained by the drain pump)—that may be advantageously used by the maintenance person to prepare himself/herself before his/her intervention in order to reduce the fixing time and costs. According to an embodiment of the present invention, the maintenance service entity may be part of the appliance management system 115, and the scheduling of the intervention by the maintenance person may be automatically carried out by a server 112 of the appliance management system 115 in response to the notification message.

According to an embodiment of the present invention, a server 112 of the appliance management system 115 is configured in such a way to provide a customer service for the electric appliance 100 with appliance log data ALD of the log LG, so that a customer service operator may display the appliance log data ALD or information derived from the appliance log data ALD on a customer service interface and help a user of the electric appliance 100 in communication with the customer service operator (e.g., through a user communication device such as the user communication device 125) to understand and/or address the malfunctioning of the electric appliance based on the appliance log data ALD displayed on customer service interface. According to an embodiment of the present invention, the customer service may be part of the appliance management system 115, and a server 112 of the appliance management system 115 may include or may be coupled with said customer service interface.

According to an embodiment of the present invention, in order to carry out the remote log data investigation on appliance log data ALD of the log LG of the electric appliance 100 for collecting detailed information about the electric appliance 100 and its operation, a server 112 of the appliance management system 115 is configured to transmit, over the external communication network 126, a request for appliance log data REQ to the electric appliance 100. In the embodiments in which the communication unit 110 of the electric appliance 100 comprises a Wi-Fi communication module, the household appliance 100 may receive the request for appliance log data REQ directly from the Wi-Fi router 120.

According to an embodiment of the present invention, in response to the reception of the request for appliance log data REQ, the electric appliance 100 is configured to transmit, over the external communication network 126, one or more appliance data packets ADP comprising at least a portion of appliance log data ALD of the log LG stored in the storage unit 130 of the electric appliance 100. In the embodiment in which the communication unit 110 of the electric appliance 100 comprises a Wi-Fi communication module, the appliance data packets ADP may be transmitted from the electric appliance 100 directly to the router 120 and then via the external telecommunication network 126 to the appliance management system 115.

Since according to the embodiments of the invention the electric appliance 100 is configured to transmit the appliance data packet ADP in response to the reception of the request for appliance log data REQ from a server 112 of the appliance management system 115, the electric appliance 100 is advantageously freed from the burden of deciding if (and when) actually carrying out the transmission of appliance log data ALD to the appliance management system 115, reducing the complexity of the operations to be carried out by the electric appliance 100. Moreover, since the electric appliance is able to transmit the appliance data packets ADP to the appliance management system 115 over the external telecommunication network 126, on request by the appliance management system 115, without first uploading them for storage in a separate local user device, security is increased. Hereinafter, when “an” or “the” application data packet ADP is referred to, it should be understood that it could be more than one or at least one ADP. Moreover, the portion of appliance log data ALD that is included in a single application data packet ADP could be the full, or a sub-portion of the, portion selected for transmission. An appliance data packet ADP should be understood to include any suitable collection, payload or structure of data for comprising appliance log data ALD and could itself be split into a number of smaller packets when sent over the network.

According to an embodiment of the present invention, the request for appliance log data REQ is transmitted by (a server 112 of) the appliance management system 115 based on the processing of an instruction INS to carry out a remote log data investigation. Compared to solutions requiring a periodic transmission of the appliance log data, the solutions according to the embodiments of the invention advantageously provide for the transmission of the appliance log data ALD only when required (e.g., following an assessment of a malfunctioning of the electric appliance 100), reducing the computation load associated with transmissions and the bandwidth used. In some implementation, the appliance is configured to, as part of its normal operations, send only the minimum of data automatically, for the normal functioning of the system, e.g. to allow remote control and/or general monitoring of the appliance. The full available log data, or a most relevant portion of the full available log data, is only transmitted by the appliance when requested.

According to an embodiment of the present invention, the instruction INS to carry out a remote log data investigation may be triggered by an assessment of the malfunctioning of the electric appliance 100. According to an embodiment of the present invention, the instruction INS to carry out a remote log data investigation may be triggered based on (e.g., in response to) an appliance malfunctioning message EM (e.g., an error code message or alarm) which may be generated by the electric appliance 100 when the latter is experiencing a malfunctioning. For example, the appliance malfunctioning message EM may be sent to (a server 112 of) the appliance management system 115 by the electric appliance 100 itself or by a user communication device associated with the electric appliance 100, such as the user communication device 125, over the external communication network 126 (or over the external communication network 126 and the mobile telecommunication network 128). Some errors may clear if the appliance is restarted and/or may not be repeated during the next operation and so a remote log data investigation may only be appropriate if the frequency of error messages is high and/or the error is of a certain nature. The appliance management system may decide to send a request for appliance log data if the malfunctioning message EM indicates one of a number of specific types of appliance errors and/or the frequency of malfunctioning messages EMs generated by the electric appliance 100 exceeds a predetermined threshold and/or the data held for the appliance otherwise indicates that a remote log data investigation is appropriate. In this way, the amount of data that needs to be transmitted is further reduced.

According to another embodiment of the present invention, the instruction INS to carry out a remote log data investigation may be triggered via a customer service interface associated with one or more servers 112 of the appliance management system 115 by an input of a customer service operative.

Accordingly, the appliance log data ALD may be sent to the appliance management system on demand, for example by a customer service operative associated with the appliance management center, or automatically if the system automatically identifies a fault or issue of sufficient severity.

According to an embodiment of the present invention, the appliance data packet ADP transmitted by the electric appliance 100 to the (one or more servers 112 of the) appliance management system 115 comprises at least a portion of the most recent appliance log data ALD among the appliance log date ALD of the log LG stored in the storage unit 130 of the electric appliance 100, i.e., among the data corresponding to the most recent (i.e., latest) entries L (i) of the log LG stored in the storage unit 130 of the electric appliance 100.

In this way, the amount of data contained in the appliance data packet ADP, and therefore the amount of data to be transmitted from the electric appliance 100 to the appliance management system 115 can be kept low, reducing the time required for the transmissions and the costs thereof, increasing at the same time the efficiency of the appliance management system 115.

According to an embodiment of the present invention, the appliance data packet ADP comprises appliance log data ALD corresponding to entries L (i) of the log LG regarding the operation of the electric appliance 100 during a time period TP comprising the time t (i) corresponding to the last (i.e., most recent) entry L (i) of the log LG. For example, the time period TP may have a length of a number of minutes, such as from 10 to 60 minutes, or a number of hours, such as from 1 to 48 hours. As a specific example, it may comprise the last 120 minutes.

According to an embodiment of the present invention, the appliance data packet ADP comprises appliance log data ALD regarding a number of last operations or operation cycles carried out by the electric appliance 100, such as for example the last 1 to 5 operations or operation cycles carried out by the electric appliance 100. As a specific example, it may comprise the last 2 or 3 operations or operation cycles. In some circumstances, the appliance data packet ADP may comprise appliance log data ALD regarding part of an operation cycle if for example the cycle stopped part way through the cycle because of a fault.

According to an embodiment of the present invention, the appliance data packet ADP comprises appliance log data ALD up to a maximum data size, such as 1 to 20 MBs. For example, in a specific example, the amount of appliance log data that can be transmitted is capped at 2 MB.

It is pointed out that since a request for appliance log data REQ is very probably transmitted by (a server 112 of) the appliance management system 115 soon after, or at least not long after, the assessment of a malfunctioning in the electric appliance 100, the probability is high that the most useful data among the appliance log data ALD to be analyzed for determining the malfunctioning cause are contained in the last (i.e., more recent) portion of the log LG. In other words, the solutions according to the embodiments of the present invention provide for the transmission of data focused on the operation period of the electric appliance 100 during which a malfunctioning most probably occurred. In this way, since the appliance log data ALD transmitted via the appliance data packet ADP relate to a relatively short time window, the level of detail of said data may be kept high, increasing the efficiency of the malfunctioning identification while keeping at the same time the overall amount of data to be transmitted under a reasonable threshold.

According to an embodiment of the present invention, one or more servers 112 of the appliance management system 115 are configured to transmit a follow-up request REQ for additional appliance log data ALD regarding events E(i) of the electric appliance 100 that are occurred during a period of time older than the one during which the events E(i) of the appliance log data ALD contained in the previously transmitted appliance data packet ADP occurred. This may be particularly useful in case a deeper investigation of the operational history of the electric appliance 100 is required, for example in case the malfunctioning started in a time substantially before the occurrence of the first request REQ.

According to an embodiment of the present invention, the amount of memory space occupied by the log LG stored in the storage unit 130 of the electric appliance 100 is advantageously kept within a predetermined limit. For example, the limit may be set to be sufficient to store appliance log data ALD corresponding to a number of consecutive operations or operations cycles of the electric appliance 100, such as for example from 2 to 50 operations or operation cycles. In some implementations, the limit may be set to a data amount between 1 MB and 50 MB. As a specific example it may be 2 MB or 5 MB. When the limit has been reached, the oldest appliance log data ALD is deleted. In one implementation, it may be overwritten with more recent appliance log data.

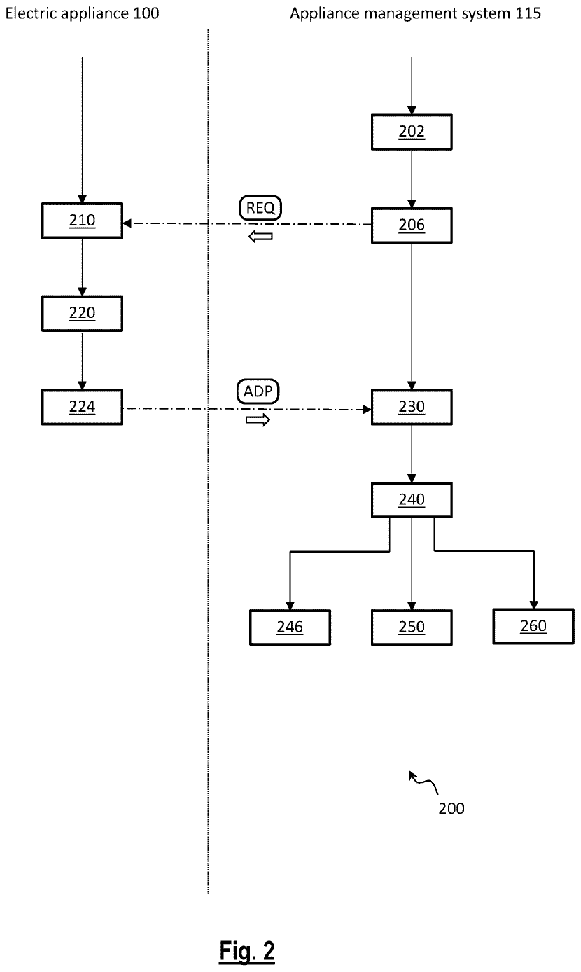

With reference now to FIG. 2, it shows an activity diagram of a method 200 implementing a remote log data investigation for the electric appliance 100 by the appliance management system 115, according to an embodiment of the present invention. FIG. 2 shows a swim-lane activity diagram which describes the flow of activities relating to an exemplary embodiment of the present invention. In this respect, each block of the activity diagram may correspond to one or more executable instructions for implementing a specified logical function on a relevant software component of a respective actor, i.e., the electric appliance 100 or one or more servers 112 of the appliance management system 115.

According to an embodiment, the method phases performed by the electric appliance 100 and by the one or more servers 112 of the appliance management system 115 may be carried out under the control of the control unit 105 (for the electric appliance 100) and of the processing unit(s) 140 (for one or more servers 112 of the appliance management system 115) through the running of respective computer program products loadable into a digital memory of the electric appliance 100 and of the one or more servers 112 of the appliance management system 115.

Without losing generality, the computer program product implementing the method phases performed by the electric appliance 100 may comprise, or be included in, a firmware of the electric appliance 100, the firmware being for example stored in a memory location of the control unit 105.

Without losing generality, the computer program product implementing the method phases performed by the one or more servers 112 of the appliance management system 115 may comprise, or be included in, a software application stored in the server storage unit 144 or stored across several server storage units 144.

According to an embodiment of the present invention, (the processing unit(s) 140 of) one or more servers 112 of the appliance management system 115 process (block 202) an instruction INS to carry out a remote log data investigation for the electric appliance 100. As already described above, the instruction INS may be triggered by one out of (the following list being not limitative nor exhaustive):
an assessment of the malfunctioning of the electric appliance 100, such as for example based on an appliance malfunctioning message EM (e.g., an error code message) sent to (a server 112 of) the appliance management system 115 by the electric appliance 100 itself or by a user communication device associated with the electric appliance 100, such as the user communication device 125; and
a user input entered by a customer service operator on a customer service interface associated with one or more servers 112 of the appliance management system 115.

According to an embodiment of the present invention, in response to the processing of the instruction INS by (the processing unit(s) 140 of) one or more servers 112 of the appliance management system 115, the server communication unit 146 (e.g., under the control of the processing unit(s) 140) of one or more servers 112 transmits (block 206) to the electric appliance 100 a request for appliance log data REQ. As already described above, the transmission is performed over the external communication network 126.

According to an embodiment of the present invention, once the request REQ has been received by the communication unit 110 of the electric appliance 100 (block 210), the (control unit 120 of the) electric appliance 100 accesses the log LG stored in the storage unit 130 and generates (block 220) an appliance data packet ADP comprising at least a portion of most recent appliance log data ALD among the appliance log data ALD of the stored log LG. As already described above, the generated appliance data packet ADP may comprise:
appliance log data ALD corresponding to entries L (i) of the log LG regarding the operation of the electric appliance 100 during a time period TP comprising the time t (i) corresponding to the last (i.e., most recent) entry L (i) of the log LG, or
appliance log data ALD regarding a number of recent (including for example the most recent) operation cycles carried out by the electric appliance 100.

According to an embodiment of the present invention, the communication unit 110 of the electric appliance 100 (e.g., under the control of the control unit 105) transmits (block 224) to a server 112 of the appliance management system 115 the generated appliance data packet ADP. As already described above, the transmission is performed over the external communication network 126.

According to an embodiment of the present invention, once the appliance data packet ADP has been received by the server communication unit 146 of a server 112 (block 230), the processing unit 140 of the, or another, server 112 may analyze (block 240) the appliance log data ALD contained in the received appliance data packet ADP, for example in order to identify a cause of a malfunctioning of the electric appliance 100.

According to an embodiment of the present invention, the identified cause of the malfunctioning may be notified to a user of the of the electric appliance 100, for example through a notification message sent to the user communication device 125 (block 246).

According to an embodiment of the present invention, the identified cause of the malfunctioning may be (instead or also) notified to a maintenance service entity in order to schedule an intervention by a maintenance person directed to fix the malfunctioning of the electric appliance 100 (block 250). In this case, according to an embodiment of the present invention, at least a portion of the appliance log data ALD included in the received appliance data packet ADP may be also provided to the maintenance service entity.

According to an embodiment of the present invention, at least a portion of the appliance log data ALD included in the received appliance data packet ADP may be provided to a customer service of the electric appliance 100 (block 260) so that a customer service operator may see it on a customer service interface and help a user of the electric appliance 100 in communication with the customer service operator (e.g., through a user communication device such as the user communication device 125) to address the malfunctioning of the electric appliance based on the appliance log data ALD displayed on the customer service interface.

It will be appreciated that although a number of operations have been described with respect to FIG. 2, some of the operations may not be present in the methods carried out by the appliance and the appliance management system. For example, the log data investigation may not include analyzing the appliance log data ALD. In some implementations, the appliance log data ALD could instead be provided or retrieved for analysis by the user, customer service operative or maintenance person. In those cases, the system may not automatically identify a cause nor notify the cause to the user/customer service operative/maintenance person. In some implementations, the appliance log data ALD is stored and then only analyzed and/or retrieved if a user calls, or otherwise contacts, the customer service center. Alternatively, a maintenance person or another user of the system could contact the appliance management system to retrieve the appliance log data ALD. In other words, operations 240, 246, 250 and 260 may not automatically follow operation 230.

Naturally, in order to satisfy local and specific requirements, a person skilled in the art may apply to the invention described above many logical and/or physical modifications and alterations. More specifically, although the present invention has been described with a certain degree of particularity with reference to preferred embodiments thereof, it should be understood that various omissions, substitutions and changes in the form and details as well as other embodiments are possible. In particular, different embodiments of the invention may even be practiced without the specific details set forth in the preceding description for providing a more thorough understanding thereof; on the contrary, well-known features may have been omitted or simplified in order not to encumber the description with unnecessary details. Moreover, it is expressly intended that specific elements and/or method steps described in connection with any disclosed embodiment of the invention may be incorporated in any other embodiment.

1. A method carried out by an appliance management system comprising one or more servers, the method comprising:
processing an instruction to carry out a log data investigation for an electric appliance, the electric appliance locally storing appliance log data regarding operation of the electric appliance;
based on said processing:
transmitting, over a communication network, a request for appliance log data to the electric appliance; and
receiving, over the communication network, from the electric appliance an appliance data packet comprising at least a portion of recent appliance log data among the appliance log data locally stored at the electric appliance.

2. The method of claim 1, wherein said appliance log data comprises at least one of:
appliance usage data indicative of interactions between a user and the electric appliance during the operation of the electric appliance; or
telemetric data collected by sensors onboard the electric appliance during the operation of the electric appliance.

3. The method of claim 1, wherein said appliance data packet comprises at least one of:
appliance log data regarding an operation of the electric appliance during a time period comprising a last, most recent, operation of the electric appliance; or
appliance log data regarding a last operation cycle carried out by the electric appliance.

4. The method according to claim 1, wherein said instruction to carry out the log data investigation is triggered by an assessment of a malfunctioning of the electric appliance.

5. The method of claim 4, further comprising:
receiving from the electric appliance or a user communication device associated with the electric appliance an appliance malfunctioning message indicative of the malfunctioning of the electric appliance, and
performing said assessment of the malfunctioning of the electric appliance based on said appliance malfunctioning message.

6. The method of claim 4, comprising:
when transmitting the request for the appliance log data, transmitting the request in response to the assessment of the malfunctioning of the electric appliance:
analyzing the received appliance data packet; and
identifying a cause of said malfunctioning based on the analyzing of the received appliance data packet.

7. The method of claim 6, further comprising:
transmitting a message to a user communication device associated with the electric appliance to notify a user of the electric appliance (100) about the identified cause and/or a repair solution, and/or
transmitting a message to a maintenance service entity to inform the maintenance service entity about the identified cause and to automatically schedule an intervention by a maintenance person directed to fix the malfunctioning.

8. The method according to claim 1, wherein said instruction to carry out the log data investigation is triggered via a customer service interface device associated with the one or more servers by a user input, and wherein the method further comprises providing the at least a portion of recent appliance log data to the customer service interface device for display to a customer service operator.

9. The method of claim 1, wherein said communication network comprises an Internet.

10. A method carried out by an electric appliance, the method comprising:
locally storing appliance log data regarding operation of the electric appliance;
receiving a request of appliance log data from a remote server; and
in response to the received request, sending to the remote server an appliance data packet comprising at least a portion of most recent appliance log data among the locally stored appliance log data.

11. The method of claim 10, wherein the method further comprises overwriting previously stored appliance log data regarding a past operation of the electric appliance with new appliance log data regarding a new operation of the electric appliance.

12. The method of claim 10, further comprising controlling sensors onboard the electric appliance to record telemetric data during the operation of the electric appliance, wherein said appliance log data comprise at least a portion of the recorded telemetric data.

13. The method of claim 10, further comprising detecting user inputs at a user interface of the electric appliance, wherein said appliance log data comprises user input data indicative of at least some of said detected user inputs.

14. The method of claim 10, wherein said appliance data packet comprises at least one among: of:
appliance log data regarding an operation of the electric appliance (100) during a time period comprising the last, most recent, operation of the electric appliance (100); or
appliance log data regarding a last operation cycle carried out by the electric appliance.

15. The method of claim 10, further comprising prior to receiving the request for the appliance log data, transmitting an appliance malfunctioning message indicative of a malfunctioning of the electric appliance.

16. The method of claim 10, further comprising receiving a follow-up request for additional appliance log data from the remote server and in response to the follow-up request, sending to the remote server another appliance data packet comprising an additional portion of recent appliance log data, said at least a portion being more recent log data than said additional portion.

17. An electric appliance, comprising:
a storage unit configured to store appliance log data regarding operation of the electric appliance;
a communication unit configured to exchange data and messages with a remote server over a communication network; and
a control unit configured to control the communication unit to send, to the remote server in response to reception of a request of appliance log data from the remote server, at least a portion of recent appliance log data among the appliance data stored in the storage unit.

18. An appliance management system comprising one or more servers, said one or more servers comprising:
a processing unit configured to process an instruction to carry out a log data investigation for a electric appliance; and
a communication unit configured to:
based on said instruction processed by the processing unit, transmit, over a communication network, to said electric appliance a request of appliance log data, said appliance log data being data regarding operation of the electric appliance that are locally stored at the electric appliance; and
receive, over the communication network (126; 126, 128), from the electric appliance at least a portion of recent appliance log data among the appliance log data locally stored at the electric appliance.

19. The appliance management system of claim 18, wherein said processing unit is further configured to analyze the received appliance log data and identify a cause of a malfunctioning of the electric appliance based on the analyzed appliance log data.

20. A non-volatile memory device comprising a computer program configured for causing a processing unit to perform the method of claim 1, when the computer program is executed by the processing unit.

21. A non-volatile memory device comprising a computer program configured for causing a processing unit to perform the method of claim 10, when the computer program is executed by the processing unit.
